(19) United States
(12) Patent Application Publication
(10) Pub. No.: US 2019/0215066 A1
(43) Pub. Date: Jul. 11, 2019

(54) OPTICAL NETWORK UNIT, OPTICAL LINE TERMINAL, OPTICAL COMMUNICATION SYSTEM, AND METHOD OF CONTROLLING OPTICAL COMMUNICATION SYSTEM

(71) Applicant: SUMITOMO ELECTRIC INDUSTRIES, LTD., Osaka-shi, Osaka (JP)

(72) Inventors: Nobuyuki TANAKA, Osaka-shi, Osaka (JP); Yasuhiro SANO, Osaka-shi, Osaka (JP)

(73) Assignee: Sumitomo Electric Industries, Ltd., Osaka-shi, Osaka (JP)

(21) Appl. No.: 16/312,351

(22) PCT Filed: May 18, 2017
(86) PCT No.: PCT/JP2017/018716

§ 371 Date: Dec. 21, 2018

(30) Foreign Application Priority Data
Aug. 3, 2016 (JP) 2016-152922

(51) Int. Cl. H04B 10/25; H04B 10/27; H04B 10/077; H04B 10/40

(52) U.S. Cl. CPC H04B 10/25; H04B 10/40; H04B 10/0779; H04B 10/27

(57) ABSTRACT

An optical network unit (ONU) includes a plurality of media access control (MAC) processing units and a storage unit which stores grouping information for grouping the plurality of MAC processing units.

### TECHNICAL FIELD

The present invention relates to an optical network unit, an optical line terminal, an optical communication system, and a method of controlling an optical communication system. The present application claims priority to Japanese Patent Application No. 2016-152922 filed on Aug. 3, 2016, contents of which are incorporated herein by reference in their entirety.

### BACKGROUND ART

A passive optical network (PON) represents one form of medium-sharing-type communication. In a PON system, a plurality of optical network units (ONUs) share an optical communication line. The plurality of ONUs transmit data to an optical line terminal (OLT).

Japanese Patent Laying-Open No. 2015-33003 (PTD 1) discloses one configuration example of an ONU. This ONU includes a variable wavelength optical transceiver, a physical (PHY)/media access control (MAC) processing unit, and a user network interface (UNI) processing unit. One PHY/MAC processing unit is provided and one UNI processing unit is provided.

### CITATION LIST

### Patent Document

### PTD 1: Japanese Patent Laying-Open No. 2015-33003

### SUMMARY OF INVENTION

An optical network unit according to one manner of the present invention includes a plurality of media access control (MAC) processing units and a storage unit which stores grouping information for grouping the plurality of MAC processing units.

An optical line terminal according to one manner of the present invention is an optical line terminal which establishes optical communication with an optical network unit including a plurality of media access control (MAC) processing units, and includes a storage unit which stores grouping information for grouping the plurality of MAC processing units of the optical network unit and an optical transceiver which transmits or receives through an optical communication line, information for collectively handling the plurality of MAC processing units of the optical network unit in accordance with the grouping information.

An optical communication system according to one manner of the present invention includes an optical communication line, an optical network unit including a plurality of media access control (MAC) processing units, and an optical line terminal. The optical line terminal registers grouping information for grouping the plurality of MAC processing units in the optical line terminal as the optical network unit is connected to the optical line terminal through the optical communication line.

A method of controlling an optical communication system according to one manner of the present invention includes connecting an optical network unit including a plurality of media access control (MAC) processing units to an optical line terminal through an optical communication line and registering grouping information for grouping the plurality of MAC processing units in the optical line terminal.

### BRIEF DESCRIPTION OF DRAWINGS

FIG. 1 is a block diagram showing a schematic configuration of a PON system according to one embodiment of the present invention.

FIG. 2 is a block diagram schematically showing a configuration of an ONU according to a first embodiment of the present invention.

FIG. 3 is a block diagram schematically showing a configuration of an OLT according to the first embodiment of the present invention.

FIG. 4 is a diagram showing an example of grouping information stored in a storage unit of the ONU.

FIG. 5 is a diagram showing an example of grouping information stored in a storage unit of the OLT.

FIG. 6 is a sequence diagram for illustrating exemplary processing for the OLT to register a group MAC list and a collective management list.

FIG. 7 is a sequence diagram for illustrating another example of processing for the OLT to register a group MAC list and a collective management list.

FIG. 8 is a sequence diagram showing an example of management by the OLT based on the group MAC list and the collective management list registered in the OLT and the ONU.

FIG. 9 is a sequence diagram showing another example of management by the OLT based on the group MAC list and the collective management list registered in the OLT and the ONU.

FIG. 10 is a block diagram showing one example of a configuration of the ONU according to a second embodiment of the present invention.

FIG. 11 is a sequence diagram for illustrating exemplary processing for the OLT to register the group MAC list and the collective management list in the second embodiment of the present invention.

FIG. 12 is a sequence diagram showing an example of management by the OLT based on the group MAC list and the collective management list registered in the OLT.

FIG. 13 is a sequence diagram showing another example of management by the OLT based on the group MAC list and the collective management list registered in the OLT.

### DESCRIPTION OF EMBODIMENTS

### Problem to be Solved by Present Disclosure

An OLT basically manages or controls an ONU with a MAC processing unit being defined as one unit. When an ONU including a plurality of MAC processing units is connected to an optical communication line, the OLT makes setting for or manages the ONU individually for each MAC processing unit. Such management, however, may be inefficient for the OLT.

An object of the present disclosure is to provide a technique for enabling efficient management of an ONU including a plurality of MAC processing units.

### Description of Embodiment of Present Invention

Embodiments of the present invention will initially be listed and described.

(1) An optical network unit according to one manner of the present invention includes a plurality of media access control (MAC) processing units and a storage unit which stores grouping information for grouping the plurality of MAC processing units.

According to the above, the plurality of MAC processing units can collectively be managed based on the grouping information stored in the optical network unit (ONU). Therefore, the ONU including the plurality of MAC processing units can efficiently be managed.

(2) Preferably, the grouping information includes first information for setting a representative MAC processing unit among the plurality of MAC processing units and second information including an item for which the plurality of MAC processing units are collectively handled. The optical network unit is configured to output the first information and the second information to the outside of the optical network unit.

According to the above, a device outside the optical network unit can obtain the grouping information from the optical network unit. For example, an optical line terminal (OLT) can collectively manage the plurality of MAC processing units included in the optical network unit based on the grouping information.

(3) Preferably, the second information further includes an item for which the plurality of MAC processing units are individually handled. The optical network unit determines whether the item to be included in the second information is an item for which the plurality of MAC processing units are collectively handled or an item for which the plurality of MAC processing units are individually handled.

According to the above, whether the plurality of MAC processing units are to be handled individually or collectively can be switched depending on an item.

(4) Preferably, the optical network unit determines whether the item to be included in the second information is an item for which the plurality of MAC processing units are collectively handled or an item for which the plurality of MAC processing units are individually handled based on information on collective or individual handling of the plurality of MAC processing units received from the outside of the optical network unit and the second information generated by the optical network unit.

According to the above, the optical network unit determines an item for which the plurality of MAC processing units are collectively handled and an item for which the plurality of MAC processing units are individually handled based on the information received by the optical network unit in addition to the information in the optical network unit itself. The second information on management of the plurality of MAC processing units can thus be updated or added.

(5) Preferably, the item for which the plurality of MAC processing units are collectively handled includes downloading of firmware to the optical network unit.

According to the above, a representative MAC processing unit can receive firmware and transfer the firmware to each MAC processing unit.

(6) Preferably, the item for which the plurality of MAC processing units are collectively handled includes monitoring of an abnormal condition of the optical network unit.

According to the above, a representative MAC processing unit can generate information on a result of monitoring of the optical network unit. Therefore, the ONU including the plurality of MAC processing units can efficiently be managed.

(7) An optical line terminal according to one manner of the present invention is an optical line terminal which establishes optical communication with an optical network unit including a plurality of media access control (MAC) processing units, and includes a storage unit which stores grouping information for grouping the plurality of MAC processing units of the optical network unit and an optical transceiver which transmits or receives through an optical communication line, information for collectively handling the plurality of MAC processing units of the optical network unit in accordance with the grouping information.

According to the above, the optical line terminal can collectively manage the plurality of MAC processing units included in the optical network unit. Therefore, the optical network unit can efficiently be managed.

(8) Preferably, the optical line terminal receives the grouping information from the optical network unit and stores the grouping information in the storage unit.

According to the above, the optical line terminal can obtain information on grouping of the plurality of MAC processing units without generation of the information by the optical line terminal itself.

(9) Preferably, the grouping information includes first information for setting a representative MAC processing unit among the plurality of MAC processing units and second information including an item for which the plurality of MAC processing units are collectively handled. The optical line terminal generates the second information to be stored in the storage unit based on the second information generated by the optical line terminal and the second information from the optical network unit.

According to the above, the optical line terminal determines an item for which the plurality of MAC processing units are collectively handled and an item for which the plurality of MAC processing units are individually handled based on the information received by the optical line terminal in addition to the information in the optical line terminal itself. The second information on management of the plurality of MAC processing units can thus be updated or added.

(10) Preferably, the optical line terminal receives the grouping information from a management device and stores the grouping information in the storage unit.

According to the above, the optical line terminal can obtain information on grouping of the plurality of MAC processing units without generation of the information by the optical line terminal itself.

(11) Preferably, the optical line terminal integrates information from each of the plurality of MAC processing units included in the optical network unit in accordance with the grouping information.

According to the above, when identical information (for example, information on an abnormal condition of the optical network unit) is sent from each of the plurality of MAC processing units to the optical line terminal, the optical line terminal can determine that such information is redundant and integrate such information into one piece of information. Therefore, the optical network unit can efficiently be managed.

(12) An optical communication system according to one manner of the present invention includes an optical communication line, an optical network unit including a plurality of media access control (MAC) processing units, and an optical line terminal. The optical line terminal registers grouping information for grouping the plurality of MAC processing units in the optical line terminal as the optical network unit is connected to the optical line terminal through the optical communication line.

According to the above, the optical line terminal can collectively manage the plurality of MAC processing units included in the optical network unit. Therefore, the optical network unit can efficiently be managed.

(13) A method of controlling an optical communication system according to one manner of the present invention includes connecting an optical network unit including a plurality of media access control (MAC) processing units to an optical line terminal through an optical communication line and registering grouping information for grouping the plurality of MAC processing units in the optical line terminal.

According to the above, the optical line terminal can collectively manage the plurality of MAC processing units included in the optical network unit. Therefore, the optical network unit can efficiently be managed.

(14) Preferably, the method of controlling an optical communication system further includes each of the plurality of MAC processing units transmitting information to the optical line terminal and the optical line terminal integrating the information from each of the plurality of MAC processing units based on the grouping information.

According to the above, when identical information is sent from each of the plurality of MAC processing units to the optical line terminal, the optical line terminal can determine that such information is redundant and integrate such information into one piece of information. Therefore, the optical network unit can efficiently be managed.

### Details of Embodiment of Present Invention

Embodiments of the present invention will be described hereinafter in detail with reference to the drawings. The same or corresponding elements in the drawings have the same reference characters allotted and description thereof will not be repeated.

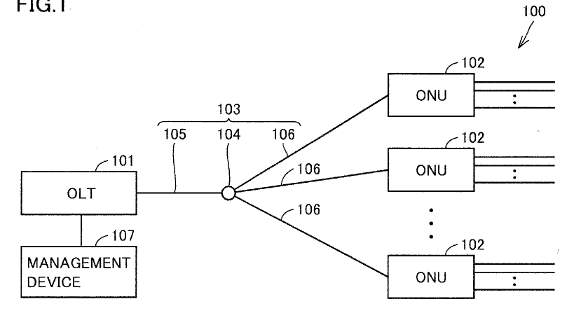

FIG. 1 is a block diagram showing a schematic configuration of a PON system according to one embodiment of the present invention. As shown in FIG. 1, a PON system 100 includes an optical line terminal (OLT) 101, a plurality of optical network units (ONU) 102, a PON line 103, and an optical splitter 104.

A user terminal (not shown) is connected to each ONU 102. The number of user terminals connected to each ONU 102 is not particularly limited. A type of the user terminal is not particularly limited either.

Connection of the user terminal is not limited to direct connection to ONU 102. A user network may be connected to ONU 102. The user terminal may be connected to ONU 102 through the user network.

PON line 103 is an optical communication line implemented by an optical fiber. PON line 103 includes a trunk optical fiber 105 and a plurality of branch optical fibers 106. Optical splitter 104 is connected to trunk optical fiber 105 and a plurality of branch optical fibers 106.

An optical signal transmitted from OLT 101 passes through PON line 103 and is branched by optical splitter 104 to the plurality of ONUs 102. Optical signals transmitted from ON Us 102 are converged by optical splitter 104 and sent to OLT 101 through PON line 103. Optical splitter 104 passively branches an input signal or multiplexes input signals without particularly requiring external power supply.

Optical signals transmitted from the ONUs are merged in optical splitter 104. Control for avoiding collision after merge of signals from the ONUs in optical splitter 104 is required. OLT 101 calculates time to start transmission and an allowable amount of transmission of data accumulated in ONU 102 based on a control frame (REPORT) transmitted from each ONU 102. Then, OLT 101 transmits a control frame (GRANT) in which an instruction signal has been inserted to ONUs 102 through PON line 103 and optical splitter 104.

Each ONU 102 notifies OLT 101 of a length of data in a buffer of that ONU itself in a form of a report at the time designated by the GRANT. Each ONU 102 receives the grant in which an instruction signal has been inserted from OLT 101. Each ONU 102 transmits data in the buffer of that ONU itself to OLT 101 together with the report, based on the instruction signal.

OLT 101 detects ONU 102 on PON line 103 by performing discovery processing. Furthermore, OLT 101 performs registration processing for registering detected ONU 102 therein.

OLT 101 is connected to a management device 107. Management device 107 monitors PON system 100. When an abnormal condition occurs in OLT 101 or any of a plurality of ONUs 102, management device 107 performs processing for notification of the abnormal condition.

In the embodiment of the present invention, at least one of the plurality of ONUs 102 includes a plurality of MAC processing units. In that ONU, a representative MAC processing unit is determined from among the plurality of MAC processing units. For an item for which the plurality of MAC processing units are preferably collectively managed or controlled, OLT 101 manages or controls the representative MAC processing unit. Embodiments of the present invention will be described in detail below.

### First Embodiment

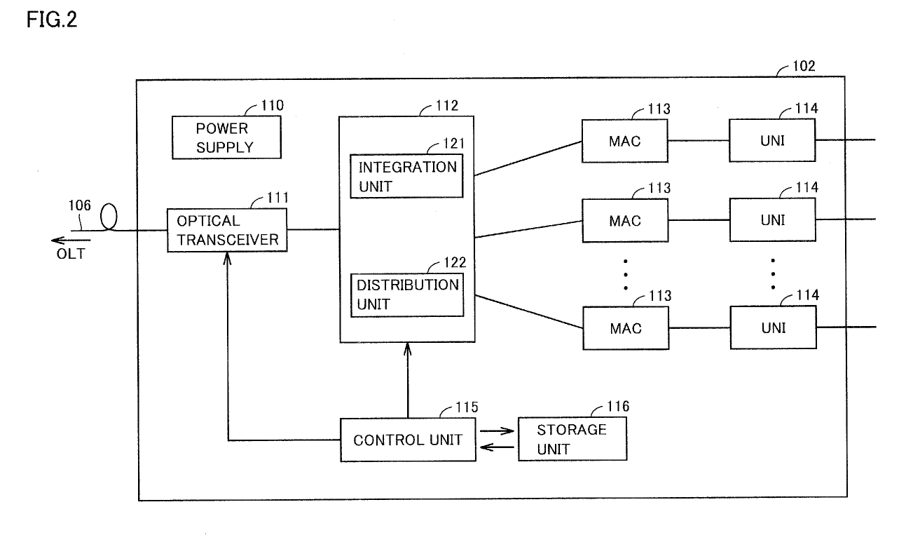

FIG. 2 is a block diagram schematically showing a configuration of ON U 102 according to a first embodiment of the present invention. As shown in FIG. 2, ONU 102 includes a power supply 110, an optical transceiver 111, a communication path setting unit 112, a plurality of MAC processing units 113, a plurality of UNI ports 114, a control unit 115, and a storage unit 116.

Power supply 110 supplies electric power to ONU 102. Optical transceiver 111 is optically connected to branch optical fiber 106. Optical transceiver 111 is a circuit for transmitting and receiving an optical signal. Optical transceiver 111 is configured to be able to convert an optical signal into an electric signal and vice versa. Optical transceiver 111 converts a downstream signal sent in a form of an optical signal from OLT 101 into an electric signal. Optical transceiver 111 converts an upstream signal sent in a form of an electric signal from any of the plurality of MAC processing units 113 into an optical signal.

Communication path setting unit 112 sets a communication path between optical transceiver 111 and the plurality of MAC processing units 113. Communication path setting unit 112 includes an integration unit 121 and a distribution unit 122. Integration unit 121 integrates a plurality of communication paths connected to the plurality of MAC processing units 113. Distribution unit 122 distributes a downstream signal transmitted from OLT 101 to the plurality of MAC processing units 113.

The configuration of integration unit 121 and distribution unit 122 for achieving the functions described above is not limited. Integration unit 121 may be implemented by an electric switch or a logical circuit. Distribution unit 122 may be implemented by a line or a logical circuit.

MAC processing unit 113 performs various types of processing on a downstream signal and an upstream signal. The downstream signal includes a MAC address indicating a destination thereof. When the MAC address of the downstream signal matches with a MAC address of MAC processing unit 113 itself, MAC processing unit 113 performs processing in accordance with a control frame included in the downstream signal. For example, MAC processing unit 113 transmits a data frame included in the downstream signal to corresponding UNI port 114. MAC processing unit 113 may perform various types of processing such as decoding processing and error correction processing in addition to the processing above.

MAC processing unit 113 receives a frame from a UNI port and analyzes a header of the frame. MAC processing unit 113 once accumulates the frame. In response to an instruction from OLT 101, one MAC processing unit of the plurality of MAC processing units 113 transmits the frame together with a burst enable signal.

UNI port 114 is connected to a user terminal device or a user network. UNI port 114 outputs a data frame sent from MAC processing unit 113. UNI port 114 receives a data frame from the user terminal device or the user network. UNI port 114 transfers the data frame to MAC processing unit 113.

Control unit 115 controls optical transceiver 111, communication path setting unit 112, and the plurality of MAC processing units 113. Storage unit 116 stores grouping information which is information for grouping the plurality of MAC processing units 113.

An internal configuration of ONU 102 is not limited as shown in FIG. 2. By way of example, control unit 115, the plurality of MAC processing units 113, and communication path setting unit 112 may be integrated. Alternatively, control unit 115 and storage unit 116 may be integrated.

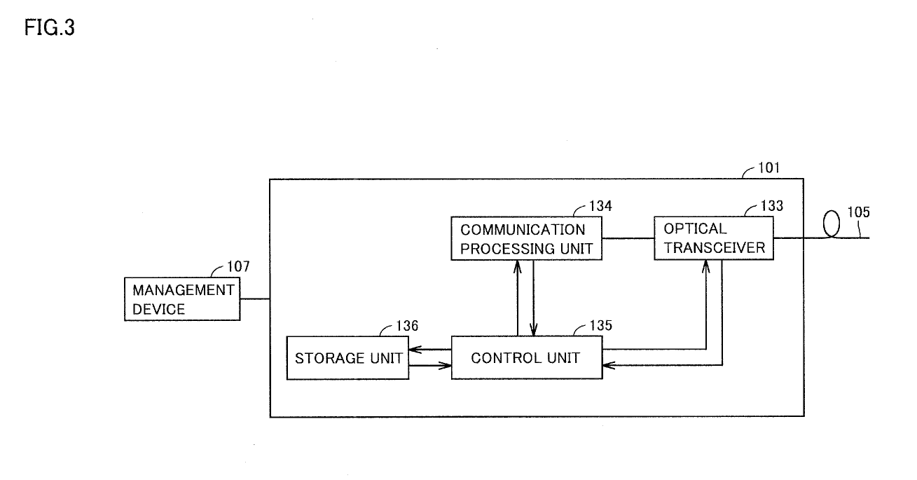

FIG. 3 is a block diagram schematically showing a configuration of OLT 101 according to the first embodiment of the present invention. As shown in FIG. 3, OLT 101 includes an optical transceiver 133, a communication processing unit 134, a control unit 135, and a storage unit 136.

Optical transceiver 133 is optically connected to trunk optical fiber 105. Similarly to optical transceiver 111, optical transceiver 133 is configured to be able to convert an optical signal into an electric signal and vice versa. Optical transceiver 133 converts an upstream signal sent in a form of an optical signal (a burst optical signal) from ONU 102 into an electric signal. Optical transceiver 133 converts a downstream signal sent in a form of an electric signal from communication processing unit 134 into an optical signal. Optical transceiver 133 sends the optical signal to trunk optical fiber 105.

Communication processing unit 134 performs various types of processing necessary for communication with ONU 102 or a not-shown higher-order device. Control unit 135 controls optical transceiver 133 and communication processing unit 134. Storage unit 136 stores various types of information for control by control unit 135. Similarly to storage unit 116 of ONU 102, storage unit 136 stores information for grouping a plurality of MAC processing units 113 included in ONU 102. Control unit 135 sets various conditions for ONU 102 or manages ONU 102 based on the grouping information.

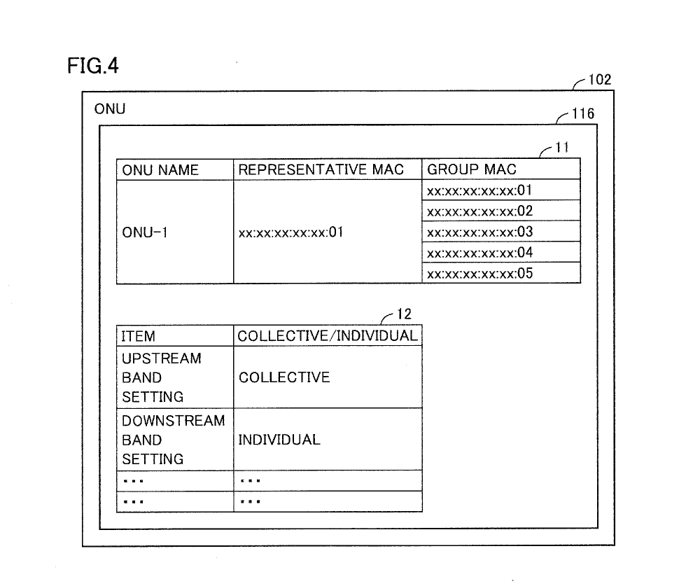

FIG. 4 is a diagram showing an example of grouping information stored in storage unit 116 of ONU 102. Referring to FIG. 4, storage unit 116 of ONU 102 includes a group MAC list 11 and a collective management list 12.

MAC processing units included in one ONU 102 form one group. Group MAC list 11 includes an ONU name (ONU-1 in the example in FIG. 4) for identifying an ONU, a group MAC address, and a representative MAC address. Group MAC list 11 is information for setting a representative MAC processing unit from among a plurality of MAC processing units 113.

The group MAC address is a MAC address of each of MAC processing units 113 which form the group. The representative MAC address is a MAC address of MAC processing unit 113 representing the group among the plurality of MAC processing units 113.

A method of determining a representative MAC address is not particularly limited. For example, a smallest address of a plurality of MAC addresses can be defined as the representative address. A largest address of the plurality of MAC addresses may be defined as the representative address.

Collective management list 12 includes an item relating to setting and management of ONU 102. Specifically, collective management list 12 includes an item for which a plurality of MAC processing units 113 are collectively handled. Collective management list 12 further includes an item for which a plurality of MAC processing units 113 are individually handled. In the example shown in FIG. 4, setting of a band in transmission of upstream data falls under an item for which a plurality of MAC processing units are collectively handled. Setting of a band in reception of downstream data falls under an item for which a plurality of MAC processing units 113 are individually handled.

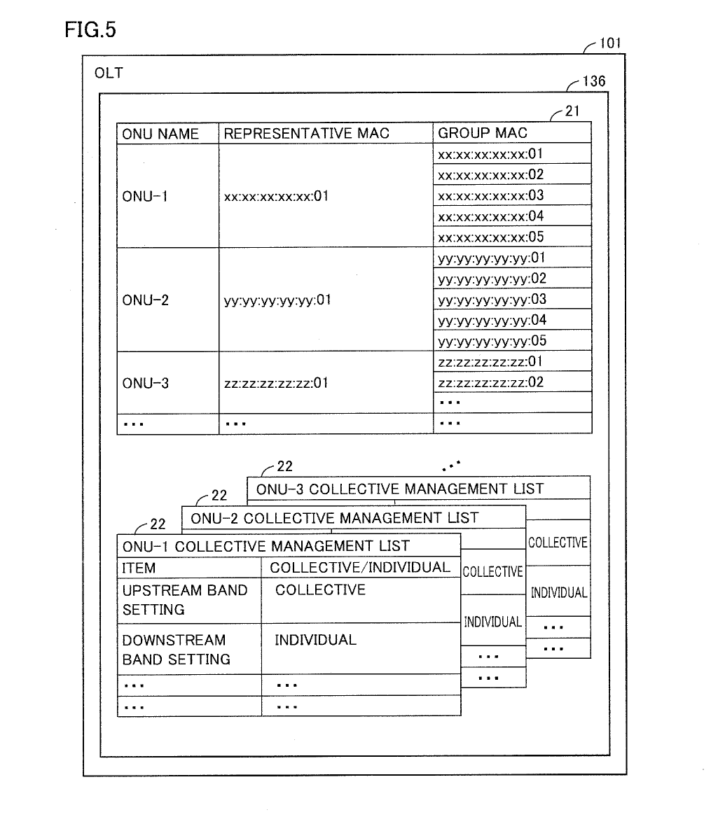

FIG. 5 is a diagram showing an example of grouping information stored in storage unit 136 of OLT 101. Referring to FIG. 5, storage unit 136 of OLT 101 holds a group MAC list 21 and a collective management list 22 for each ONU 102. Group MAC list 21 corresponds to a combination of group MAC lists 11 of ONUs 102. Group MAC list 21 includes a group MAC address and a representative MAC address for each ONU 102.

Each collective management list 22 includes an item for which a plurality of MAC processing units 113 included in ONU 102 linked to collective management list 22 are collectively handled. Collective management list 22 further includes an item for which the plurality of MAC processing units 113 are individually handled.

Information (an item) registered in collective management lists 12 and 22 is not limited as above. For example, an item common to a plurality of MAC processing units 113, in other words, a single item which exists in a single ONU 102, can be controlled or managed collectively for ONU 102. Examples of a specific item include control of the power supply of ONU 102 (for example, restart of ONU 102), a physical distance (a fiber length) between OLT 101 and ONU 102, and monitoring of a state of optical transceiver 111 (for example, a small form-factor pluggable (SFP) optical transceiver). Therefore, these items can be registered in collective management lists 12 and 22, as items for which a plurality of MAC processing units are collectively handled.

There is an item for which individual MAC processing unit 113 or a plurality of MAC processing units 113 as a whole may be defined as a unit of control or management. Such an item also falls under an item for which a plurality of MAC processing units 113 can collectively be handled. Specific examples of such an item include update of firmware of each of a plurality of MAC processing units 113.

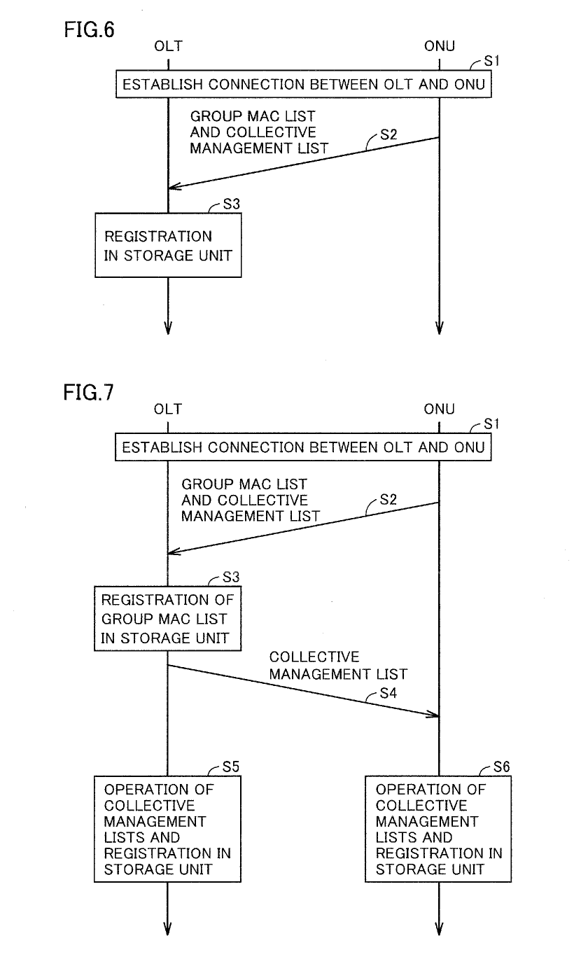

In the first embodiment, OLT 101 obtains a group MAC list and a collective management list from ONU 102. FIG. 6 is a sequence diagram illustrating exemplary processing for OLT 101 to register a group MAC list and a collective management list.

Referring to FIG. 6, in step S1, connection between OLT 101 and ONU 102 is established. When ONU 102 is physically connected to PON line 103 or when ONU 102 is started up while it is physically connected to PON line 103, OLT 101 detects ONU 102 on PON line 103 by performing discovery processing. Furthermore, OLT 101 performs registration processing for registering detected ONU 102 in OLT 101. For establishing connection between OLT 101 and ONU 102, for example, a multi-point control protocol (MPCP) is used.

In step S2, ONU 102 generates group MAC list 11 and collective management list 12. For doing so, ONU 102 (for example, control unit 115) determines whether an item to be included in collective management list 12 is an item for which a plurality of MAC processing units 113 are collectively handled or an item for which a plurality of MAC processing units 113 are individually handled.

As shown in FIG. 4, ONU 102 holds group MAC list 11 and collective management list 12 in storage unit 116. ONU 102 transfers group MAC list 11 and collective management list 12 to OLT 101.

In step S3, OLT 101 receives the group MAC list and the collective management list from each ONU 102 connected to PON line 103 and registers the group MAC list and the collective management list in storage unit 136. Group MAC list 11 from each ONU 102 is registered in storage unit 136 of OLT 101 as group MAC list 21. OLT 101 can obtain information on grouping of a plurality of MAC processing units 113 without generation of the information by the OLT itself.

Collective management list 12 sent from ONU 102 to OLT 101 is registered as collective management list 22 in storage unit 136 of OLT 101. Therefore, storage unit 136 holds collective management list 22 for each ONU 102 (see FIG. 5).

FIG. 7 is a sequence diagram for illustrating another example of processing for OLT 101 to register the group MAC list and the collective management list. Referring to FIG. 7, in step S1, connection between OLT 101 and ONU 102 is established. In step S2, ONU 102 generates group MAC list 11 and collective management list 12. ONU 102 transfers group MAC list 11 and collective management list 12 to OLT 101.

In step S3, OLT 101 receives the group MAC list and the collective management list from ONU 102. OLT 101 registers the group MAC list in storage unit 136.

In step S4, OLT 101 creates a collective management list and transfers the collective management list to ONU 102.

In step S5, OLT 101 operates AND of collective management list 12 transferred from ONU 102 and the collective management list created by OLT 101. A result thereof is registered in storage unit 136 as collective management list 22 of ONU 102.

In step S6, ONU 102 calculates AND of the collective management list received from OLT 101 through PON line 103 and the collective management list created by ONU 102 itself. A result thereof is registered in storage unit 116 as collective management list 12.

OLT 101 determines whether an item to be included in collective management list 22 is an item for which a plurality of MAC processing units 113 are collectively handled or an item for which a plurality of MAC processing units 113 are individually handled based on the collective management list received from ONU 102 and the collective management list created by OLT 101 itself. Similarly, ONU 102 determines whether an item to be included in collective management list 12 is an item for which a plurality of MAC processing units 113 are collectively handled or an item for which a plurality of MAC processing units 113 are individually handled based on the collective management list received from OLT 101 and the collective management list created by ONU 102 itself.

Thus, each of OLT 101 and ONU 102 can update or add the collective management list. In particular, in the sequence shown in FIG. 7, the collective management list identical in content can be registered in storage unit 136 of OLT 101 and storage unit 116 of ONU 102.

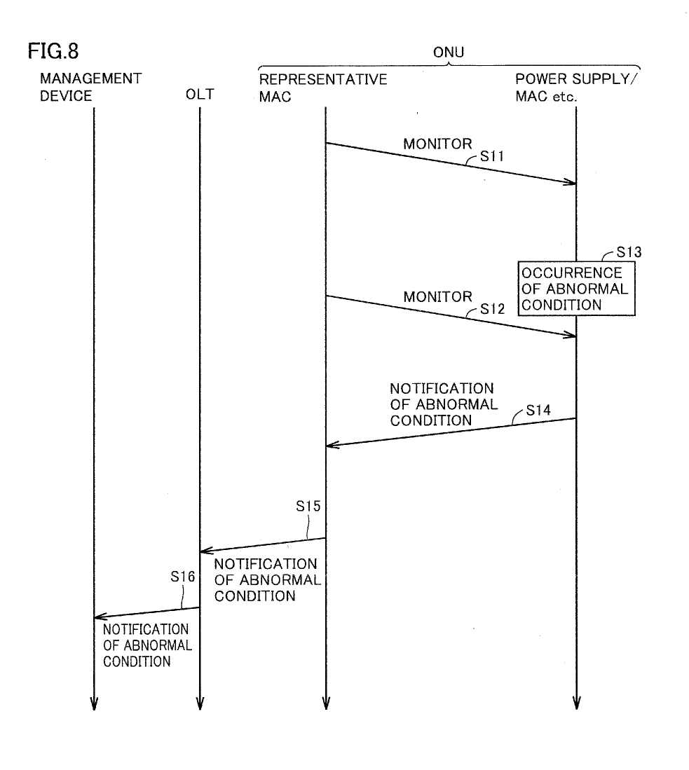

FIG. 8 is a sequence diagram showing an example of management by the OLT based on the group MAC list and the collective management list registered in OLT 101 and ONU 102. FIG. 8 illustrates monitoring of an abnormal condition of the power supply of ONU 102 or MAC processing unit 113.

In steps S11 and S12, a representative MAC processing unit among a plurality of MAC processing units 113 monitors the inside of ONU 102 (MAC processing unit 113 or power supply 110 of ONU 102).

For example, an abnormal condition occurs in power supply 110 (step S13). Representative MAC processing unit 113 is notified of occurrence of the abnormal condition in power supply 110 (step S14).

In step S15, representative MAC processing unit 113 notifies OLT 101 of occurrence of the abnormal condition in power supply 110 of ONU 102. OLT 101 receives the notification from representative MAC processing unit 113. OLT 101 refers to group MAC list 21 stored in storage unit 136 and collective management list 22 linked to ONU 102. OLT 101 specifies ONU 102 where the abnormal condition has occurred based on the MAC address of MAC processing unit 113 which has notified the OLT of the abnormal condition and detects occurrence of the abnormal condition in ONU 102.

In step S16, OLT 101 notifies management device 107 of occurrence of the abnormal condition in ONU 102.

Basically, OLT 101 or management device 107 carries out management for each MAC address. If an abnormal condition occurs in ONU 102 and each of a plurality of MAC processing units 113 notifies OLT 101 of the abnormal condition, management by OLT 101 will become complicated.

In the first embodiment, OLT 101 and ONU 102 store MAC group list 11 and collective management list 12. ONU 102 determines a representative MAC processing unit 113 from among a plurality of MAC processing units 113 in accordance with MAC group list 11. Representative MAC processing unit 113 monitors an abnormal condition in ONU 102 in accordance with collective management list 12.

When an abnormal condition of ONU 102 is detected, representative MAC processing unit 113 notifies OLT 101 of the abnormal condition. Therefore, each of the plurality of MAC processing units 113 can be prevented from sending identical information to OLT 101. Management by OLT 101 can thus be prevented from becoming complicated. OLT 101 can specify ONU 102 where an abnormal condition has occurred based on the MAC address of representative MAC processing unit 113 and information in MAC group list 21.

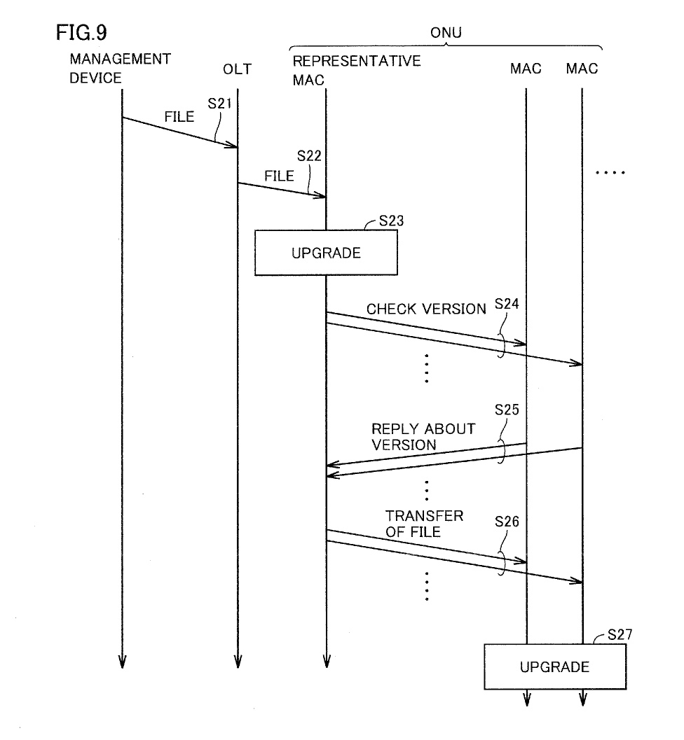

FIG. 9 is a sequence diagram showing another example of management by the OLT based on the group MAC list and the collective management list registered in OLT 101 and ONU 102. FIG. 9 illustrates update of firmware of each MAC processing unit 113 of ONU 102.

In step S21, a file for updating firmware of MAC processing unit 113 is transferred from management device 107 to OLT 101.

Control unit 135 of OLT 101 determines that processing for updating firmware of MAC processing unit 113 is processing that can collectively be managed by referring to collective management list 22. Furthermore, control unit 135 specifies representative MAC processing unit 113 of each ONU 102 in accordance with MAC group list 21. Control unit 135 and communication processing unit 134 perform transmission processing for transmitting the file to representative MAC processing unit 113.

In step S22, OLT 101 transfers the file to each ONU 102. In each ONU 102, representative MAC processing unit 113 receives the file. Firmware is downloaded to ONU 102.

In step S23, representative MAC processing unit 113 upgrades firmware of the representative MAC processing unit itself. In step S24, representative MAC processing unit 113 checks a version of firmware of other MAC processing units 113. Specifically, representative MAC processing unit 113 inquires of other MAC processing units 113 about the version of the firmware.

In step S25, in response to the inquiry, each MAC processing unit 113 provides a reply about the version of the firmware to representative MAC processing unit 113. In step S26, representative MAC processing unit 113 transfers the file for update to MAC processing unit 113 which requires upgrade of the firmware. Normally, a version of firmware is identical among a plurality of MAC processing units 113 included in a single ONU 102. In step S27, each MAC processing unit 113 updates its firmware.

If representative MAC processing unit 113 has not been determined, OLT 101 should check a version of firmware of all MAC processing units 113. Furthermore, OLT 101 should transmit a file for update to MAC processing units 113 which require update of the firmware. Therefore, when one ONU 102 includes a plurality of MAC processing units 113, OLT 101 may transmit files as many as MAC processing units 113 to that ONU 102.

In the first embodiment, one MAC processing unit 113 representing a plurality of MAC processing units 113 downloads firmware for update. That MAC processing unit 113 transfers the file to other MAC processing units. Therefore, OLT 101 can collectively manage a plurality of MAC processing units 113 included in one ONU.

### Second Embodiment

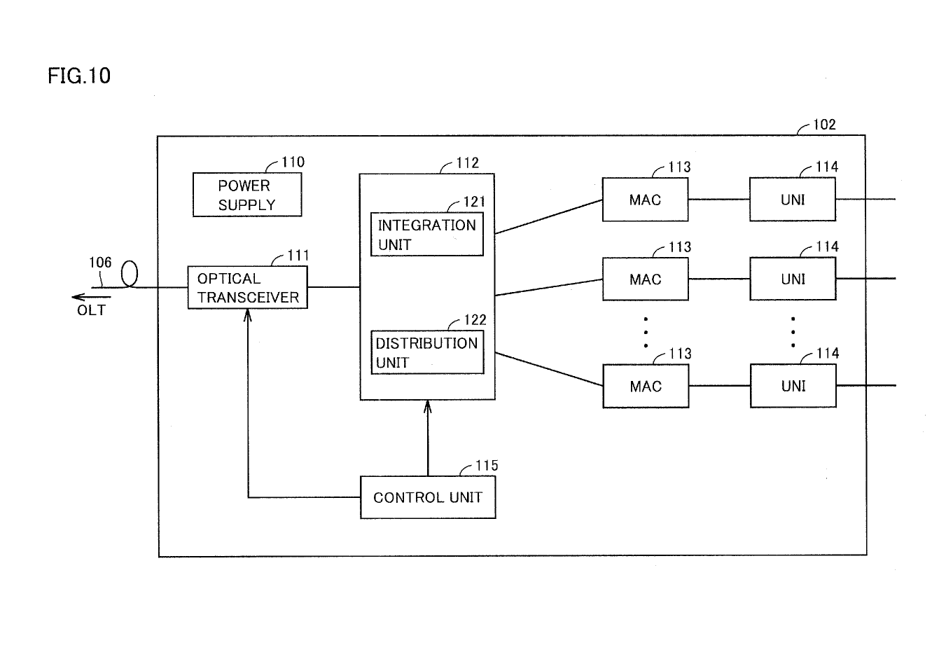

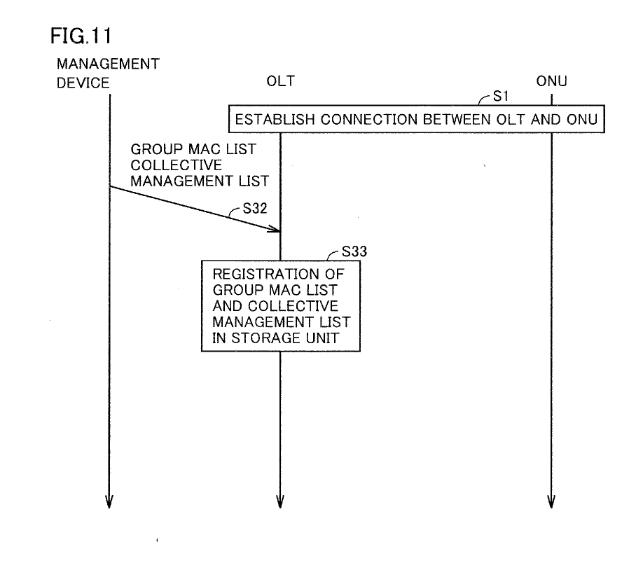

FIG. 10 is a block diagram showing one example of a configuration of the ONU according to a second embodiment of the present invention. Referring to FIGS. 2 and 10, in the second embodiment, ONU 102 does not include storage unit 116 for storing a MAC group list and a collective management list. The second embodiment is different in this regard from the first embodiment. In the second embodiment, OLT 101 holds the MAC group list and the collective management list.

FIG. 11 is a sequence diagram for illustrating exemplary processing for OLT 101 to register the group MAC list and the collective management list in the second embodiment of the present invention. Referring to FIG. 11, in step S1, connection between OLT 101 and ONU 102 is established. In step S32, management device 107 transfers the MAC group list and the collective management list to OLT 101. The MAC group list and the collective management list are input to management device 107, for example, by an operator and transferred from management device 107 to OLT 101. In step S33, OLT 101 (for example, control unit 135) registers the group MAC list and the collective management list in storage unit 136. OLT 101 can obtain information on grouping of a plurality of MAC processing units 113 without generation of the information by the OLT itself.

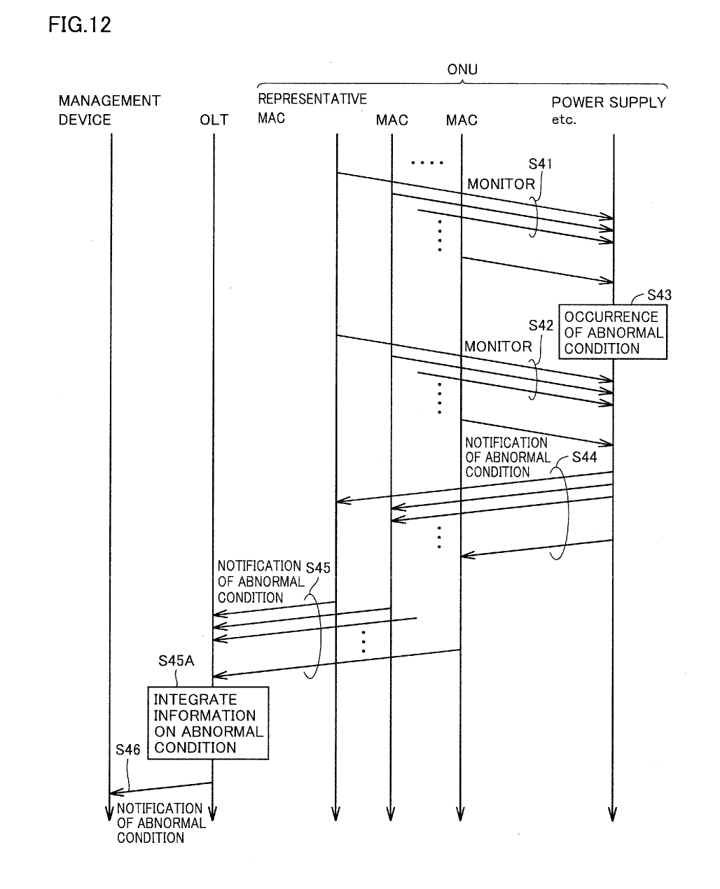

FIG. 12 is a sequence diagram showing an example of management by the OLT based on the group MAC list and the collective management list registered in OLT 101. FIG. 12 illustrates monitoring of an abnormal condition of power supply 110 of ONU 102 or MAC processing unit 113.

In steps S41 and S42, each of a plurality of MAC processing units 113 including the representative MAC processing unit monitors, for example, power supply 110.

An abnormal condition occurs in power supply 110 (step S43). Each of the plurality of MAC processing units 113 is notified of occurrence of the abnormal condition in power supply 110 (step S44).

In step S45, each MAC processing unit 113 notifies OLT 101 of occurrence of the abnormal condition in power supply 110 of ONU 102 (step S45).

OLT 101 receives a notification from each MAC processing unit 113. OLT 101 integrates information sent from MAC processing units 113 by referring to group MAC list 21 and collective management list 22 stored in storage unit 136 (step S45A).

OLT 101 can specify representative MAC processing unit 113 based on the MAC address of each MAC processing unit 113 and group MAC list 21. Information sent from MAC processing units 113 can thus be integrated. OLT 101 transfers the integrated information to management device 107 (step S46). Each of the plurality of MAC processing units 113 sends identical information to OLT 101. OLT 101 determines that such information is redundant and can integrate such information into one piece of information. Therefore, OLT 101 can efficiently manage ONU 102.

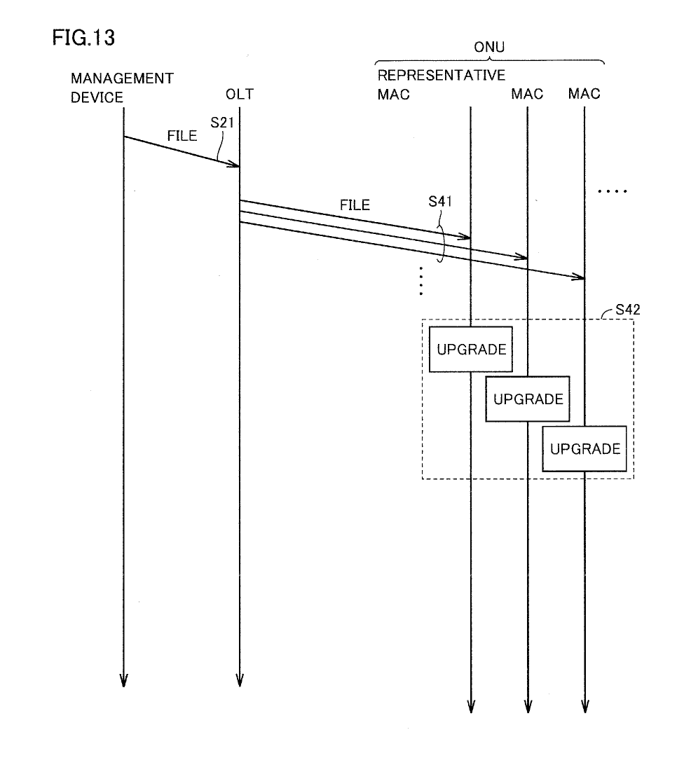

FIG. 13 is a sequence diagram showing another example of management by the OLT based on the group MAC list and the collective management list registered in OLT 101. FIG. 13 illustrates update of firmware of each MAC processing unit 113 of ONU 102.

In the second embodiment, update of firmware of MAC processing unit 113 is individual processing for each MAC processing unit 113. Storage unit 136 of OLT 101 stores collective management list 22. Update of firmware falling under individual processing is registered in collective management list 22. Control unit 135 determines that update of firmware of MAC processing unit 113 falls under individual processing by referring to collective management list 22.

In step S21, a file for updating firmware of MAC processing unit 113 is transferred from management device 107 to OLT 101. In step S41, control unit 135 of OLT 101 transfers the file to each MAC processing unit 113 of ONU 102. In step S42, each MAC processing unit 113 updates (upgrades) its firmware.

As set forth above, according to the second embodiment, ONU 102 does not have to hold the group MAC list and the collective management list. Since OLT 101 holds the group MAC list of each ONU, management of ONU 102 can be facilitated.

It should be understood that the embodiments disclosed herein are illustrative and non-restrictive in every respect. The scope of the present invention is defined by the terms of the claims rather than the embodiments above, and is intended to include any modifications within the scope and meaning equivalent to the terms of the claims.

### REFERENCE SIGNS LIST

11, 21 group MAC list; 12, 22 collective management list; 100 PON system; 103 PON line; 104 optical splitter; 105 trunk optical fiber; 106 branch optical fiber; 107 management device; 110 power supply; 111, 133 optical transceiver; 112 communication path setting unit; 113 MAC processing unit; 114 UNI port; 115, 135 control unit; 116, 136 storage unit; 121 integration unit; 122 distribution unit; 134 communication processing unit; S1 to S6, S11 to S16, S21 to S27, S32, S33, S41 to S46, S45A step

1: An optical network unit comprising:
a plurality of media access control (MAC) processing units; and
a storage unit which stores grouping information for grouping the plurality of MAC processing units.

2: The optical network unit according to claim 1, wherein
the grouping information includes
first information for setting a representative MAC processing unit among the plurality of MAC processing units, and
second information including an item for which the plurality of MAC processing units are collectively handled, and
the optical network unit is configured to output the first information and the second information to outside of the optical network unit.

3: The optical network unit according to claim 2, wherein
the second information further includes an item for which the plurality of MAC processing units are individually handled, and
the optical network unit determines whether the item to be included in the second information is an item for which the plurality of MAC processing units are collectively handled or an item for which the plurality of MAC processing units are individually handled.

4: The optical network unit according to claim 2, wherein
the optical network unit determines whether the item to be included in the second information is an item for which the plurality of MAC processing units are collectively handled or an item for which the plurality of MAC processing units are individually handled based on information on collective or individual handling of the plurality of MAC processing units received from the outside of the optical network unit and the second information generated by the optical network unit.

5: The optical network unit according to claim 2, wherein
the item for which the plurality of MAC processing units are collectively handled includes downloading of firmware to the optical network unit.

6: The optical network unit according to claim 2, wherein
the item for which the plurality of MAC processing units are collectively handled includes monitoring of an abnormal condition of the optical network unit.

7: An optical line terminal which establishes optical communication with an optical network unit including a plurality of media access control (MAC) processing units, the optical line terminal comprising:
a storage unit which stores grouping information for grouping the plurality of MAC processing units of the optical network unit; and
an optical transceiver which transmits or receives through an optical communication line, information for collectively handling the plurality of MAC processing units of the optical network unit in accordance with the grouping information.

8: The optical line terminal according to claim 7, wherein
the optical line terminal receives the grouping information from the optical network unit and stores the grouping information in the storage unit.

9: The optical line terminal according to claim 7, wherein
the grouping information includes
first information for setting a representative MAC processing unit among the plurality of MAC processing units, and
second information including an item for which the plurality of MAC processing units are collectively handled, and
the optical line terminal generates the second information to be stored in the storage unit based on the second information generated by the optical line terminal and the second information from the optical network unit.

10: The optical line terminal according to claim 7, wherein
the optical line terminal receives the grouping information from a management device and stores the grouping information in the storage unit.

11: The optical line terminal according to claim 7, wherein
the optical line terminal integrates information from each of the plurality of MAC processing units included in the optical network unit in accordance with the grouping information.

12: An optical communication system comprising:
an optical communication line;
an optical network unit including a plurality of media access control (MAC) processing units; and
an optical line terminal,
the optical line terminal registering grouping information for grouping the plurality of MAC processing units in the optical line terminal as the optical network unit is connected to the optical line terminal through the optical communication line.

13: A method of controlling an optical communication system comprising:
connecting an optical network unit including a plurality of media access control (MAC) processing units to an optical line terminal through an optical communication line; and
registering grouping information for grouping the plurality of MAC processing units in the optical line terminal.

14: The method of controlling an optical communication system according to claim 13, the method further comprising:
each of the plurality of MAC processing units transmitting information to the optical line terminal; and
the optical line terminal integrating the information from each of the plurality of MAC processing units based on the grouping information.
